(19) United States
(12) Patent Application Publication
(10) Pub. No.: US 2025/0343798 A1
(43) Pub. Date: Nov. 6, 2025

(54) SYSTEMS AND METHODS FOR DYNAMIC TEMPORARY MEMBERSHIP AND DATA ACCESS

(71) Applicant: Palantir Technologies Inc., Denver, CO (US)

(72) Inventors: Akshay Agrawal, Jersey City, NJ (US); Pieris Christofi, London (GB); Noah Öhrner, London (GB); Felipe Vieira Coimbra, London (GB); Paul Dimitri Mustière, London (GB); Dylan Cooke, Hilton Head, SC (US); Jack Wickham, London (GB); Vinícius Pereira, London (GB); Naaman Tan Yong-Jia, London (GB)

(21) Appl. No.: 18/906,450

(22) Filed: Oct. 4, 2024

Related U.S. Application Data
(60) Provisional application No. 63/641,836, filed on May 2, 2024.

(51) Int. Cl. H04L 9/40

(52) U.S. Cl. CPC H04L 63/102; H04L 63/108; H04L 63/20

(57) ABSTRACT

In some examples, systems and methods for managing data access are provided. For example, a method includes: receiving a data access request for a user, the data access request including a resource indication of a data resource; providing the user a membership of an access group associated with the data resource; determining a member temporal parameter associated with the data resource based on one or more temporal parameters associated with the access group; and associating the member temporal parameter with the user.

This application claims priority U.S. Provisional Application No. 63/641,836, filed May 2, 2024, which is incorporated in its entirety by reference herein for all purposes.

### FIELD

Certain embodiments of the present disclosure relate to managing data access. More particularly, some embodiments of the present disclosure relate to temporary data access.

### BACKGROUND

Organizations often use computing systems and/or platforms to solve real-world problems. During the process, in examples, the computing systems and/or platforms often generate, access, and/or manage large amount of data. In some embodiments, data from different data sources may have different data access requirements.

Hence, it is desirable to improve techniques for managing data access.

### SUMMARY

Certain embodiments of the present disclosure relate to managing data access. More particularly, some embodiments of the present disclosure relate to temporary data access.

At least some embodiments are directed to a method for managing data access. In certain embodiments, the method includes: receiving a data access request for a user, the data access request including a resource indication of a data resource; providing the user a membership of an access group associated with the data resource; determining a member temporal parameter associated with the data resource based on one or more temporal parameters associated with the access group; and associating the member temporal parameter with the user; wherein the method is performed by one or more processors.

At least some embodiments are directed to a system for managing data access. In some embodiments, the system includes: one or more memories comprising instructions stored thereon; and one or more processors configured to execute the instructions and perform operations comprising: receiving a data access request for a user, the data access request including a resource indication of a data resource; providing the user a membership of an access group associated with the data resource; determining a member temporal parameter associated with the data resource based on one or more temporal parameters associated with the access group; and associating the member temporal parameter with the user.

At least some embodiments are directed to a non-transitory computer-readable storage medium having instructions for managing data access that, when executed by one or more processors, cause the one or more processors to perform operations comprising: receiving a data access request for a user, the data access request including a resource indication of a data resource; providing the user a membership of an access group associated with the data resource; determining a member temporal parameter associated with the data resource based on one or more temporal parameters associated with the access group; and associating the member temporal parameter with the user.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is a simplified diagram showing a method for managing data access according to certain embodiments of the present disclosure.

FIG. 2 is an illustrative data-access management environment according to certain embodiments of the present disclosure.

FIG. 3 illustrates an example user interface for creating and/or managing an access group according to certain embodiments of the present disclosure.

FIG. 4 illustrates an example set of entities including groups, members, and data resources, according to certain embodiments of the present disclosure.

FIG. 5 is an example data access request according to certain embodiments of the present disclosure.

FIG. 6 is an illustrative example of audit process according to certain embodiments of the present disclosure.

FIG. 7 is an illustrative example of an access matrix according to certain embodiments of the present disclosure.

FIG. 8 is a simplified diagram showing a computing system for implementing a system for data-access management in accordance with at least one example set forth in the disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any number within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods often allow data access indefinitely. For example, data access may be allowed long after the expiration of the purpose that data is used for. Additionally, conventional systems and methods often do not address data access in a temporal manner, such that conventional systems and methods may have provided data access longer than needed.

Various embodiments of the present disclosure can achieve benefits and/or improvements by using a data-access management system (e.g., software module) to manage data access dynamically. In certain embodiments, the data-access management system uses and/or assigns one or more temporal parameters, also referred to as time constraints or temporal parameter values, when access request associated with one or more resources and/or one or more groups (e.g., group membership), for example, to improve efficiencies. In some embodiments, the data-access management system can use an artificial intelligence (AI) model (e.g., a language model (LM), a large language model (LLM), etc.) to generate code for managing group membership (e.g., adding a member to a group) with one or more access control parameters. In certain embodiments, the data-access management system can manage the temporary data access (e.g., using one or more temporal parameters, using one or more time constraints) to certain data in large scale (e.g., hundreds of datasets, many data sources, etc.).

According to some embodiments, systems and methods of the present disclosure manage data access. In certain embodiments, systems and methods of the present disclosure manage data access with one or more time constraints. In some embodiments, at least one of one or more entities' data access is subject to one or more time constraints, for example, represented using one or more temporal parameters. In some embodiments, a parameter includes a parameter type and a parameter value. For example, the parameter types for a temporal parameter include an access duration, a membership duration, an access expiration, a membership expiration, an access maximum duration, a membership maximum duration, and/or the like. In certain embodiments, an entity can be a group (e.g., a plurality of users, etc.), a member of a group, a project, and/or the like.

According to certain embodiments, a common data governance concern relates to users having indefinite access to data, for example, long after the expiration of whatever purpose that data was used for. Additionally, in some embodiments, various data requirements (e.g., data related regulations, data privacy legislations, etc.) include some common data protection principles like data minimization and use limitation. In certain embodiments, time-bound access to resources is generally considered to adhere to those data protection principles. As a result, in some embodiments, data protection impact assessments (DPIAs) often include explicit mentions to the time horizon related to both data access and data use. In certain embodiments, conventional systems are lack of a technology enforcement solution.

According to some embodiments, the data-access management system that allows users temporary membership to groups and temporary access to data (e.g., project data, etc.) resulting from membership to that group (which have membership to the project). In certain embodiments, a group, also referred to as an access group, includes one or more members (e.g., membership). In some embodiments, a group includes a plurality of members. By configuring group properties such as latest expiration, maximum duration, and/or the like, in certain embodiments, administrators can enforce temporary memberships and access to data. In some embodiments, this allows for flexible configuration at group creation or post-creation, ensuring that users have restricted access to data for a limited period.

According to certain embodiments, the use of groups instead of direct data access comes with the advantage of managing access to data with different levels of granularity (e.g., different time constraints, different access to data (view, edit, etc.)) at scale (e.g., across multiple systems). In some embodiments, the temporary memberships to groups can have better control of data accesses to a data resource (e.g., a data source, data for projects, etc.).

According to some embodiments, a data-access management system can set multiple types of time constraints (e.g., time conditions) on a group including, for example, before and/or after group creation. In certain embodiments, the data-access management system can set a plurality of time constraints (e.g., time conditions) including a first temporal parameter for a member and/or a group, which is a latest expiration, referring to as the last date when anyone can have membership to a group. In some embodiments, the data-access management system can set a plurality of time constraints including a second temporal parameter for a member and/or a group, which is a maximum duration referring to the maximum continuous number of days anyone can have membership to a group. In certain embodiments, the data-access management system can set a plurality of time constraints including a third temporal parameter for a member and/or a group, which is a last day, referring to the last day that anyone can access to one or more datasets for a project. In some embodiments, the data-access management system can set a set a plurality of time constraints including a fourth temporal parameter for a member and/or a group, which is a duration of data access. For example, a time constraint indicates that everyone will have access till a certain date (e.g., Dec. 15, 2023), but they can only have the data access for a certain duration at a time (e.g., 15 days at a time, 15 hours at a time, 3 weeks at a time, etc.).

According to certain embodiments, the data-access management system can grant one user multiple access roles with one or more temporal parameters (e.g., time constraints, expiration, duration, etc.) for each role. In some examples, the data-access management can compute one or more implied temporal parameters and inherited temporal parameters as a function of membership to groups, while these members can be members to other groups with the other group's time constraints. In certain embodiments, the data-access management system can include traversing a group hierarchy to determine one or more implied and/or inherited time constraints. In some embodiments, the system can compute one or more implied and/or inherited temporal parameters based on a group hierarchy and/or policy (e.g., rules).

According to some embodiments, the data-access management system can surface (e.g., alert, notification, etc.) the implications of the temporal parameters (e.g., time constraints) at the appropriate user level, group level and/or project level. In certain embodiments, a user could be part of multiple groups with a different role on each and different expiration times to each group. In some embodiments, the groups themselves having a different role on projects/resources; in-turn granting the user differing time-expiring/time-bound access to projects/resources.

According to certain embodiments, the data-access management system can set values of membership temporal parameters (e.g., time constraints) both synchronously by a group administrator and/or asynchronously by a user requesting membership to a group and membership being granted after approval from a group administrator. In some embodiments, asynchronous membership requests are capped by the implied temporal parameters (e.g., time constraints) and/or inherited temporal parameters (e.g., time constraints) set against the group. In certain embodiments, the data-access management system can define time contracts asynchronously by a user or an administrator granting membership to a group with a temporal parameter (e.g., a time constraint, a time-based condition) different than that of other users, but still compliant with the group's restrictions.

According to some embodiments, the data-access management system can dynamically and/or repeatedly update to the temporal parameters (e.g., time constraints, time conditions) resulting in extension and/or truncation of the time constraints (e.g., time conditions) and the members access as a result. In some embodiments, the data-access management system can resolve permissions around who should be able to review (approve, reject) or edit time-bound requests in the approvals service. In certain embodiments, the data-access management system can generate the request and expiration audit logs to be accessible to administrators and the users (e.g., before expiration, post-expiration). In some embodiments, the data-access management system includes a user interface providing information of data access information including, for example, data access time constraints, group members, resource information, and/or the like. In certain embodiments, a resource refers to a dataset, one or more datasets for a project, one or more data sources for a project, one or more datasets, one or more data sources, and/or the like.

According to certain embodiments, the data-access management system can include one or more computing models (e.g., one or more artificial intelligence (AI) models), also referred to as access models, for generating and/or modifying one or more data-access parameters (e.g., configurations). In some embodiments, a model, also referred to as a computing model, includes a model to process data. A model includes, for example, an artificial intelligence (AI) model, a machine learning (ML) model, a deep learning (DL) model, an image processing model, an algorithm, a rule, other computing models, and/or a combination thereof. In certain embodiments, a data-access AI model can generate data access parameters for members, groups, users, organizations, projects, and/or the like. In some embodiments, organizations can include one or more groups.

In certain examples, a data-access AI model can include training data (e.g., a part of training corpus) embedded in the model. In some embodiments, the data-access AI model includes a generative AI (artificial intelligence) model with training data embedded in the model. In certain embodiments, a generative AI model is a type of AI model that can be used to produce various type of content, such as text, images, videos, audio, 3D (three-dimensional) data, 3D models, and/or the like. In some embodiments, a language model or a large language model (LLM), which is a type of generative AI models, includes content and training data embedded in the model. In certain embodiments, a generative AI model may be subject to greater risk of data leaks with the training data embedded in the model.

According to some embodiments, the data-access AI model (e.g., a language model, an LLM, etc.) can be trained using selected corpus (e.g., historical access parameters, historical project context, historical group data, historical time constraints for one or more accesses, historical roles, etc.) and the data-access AI model is configured to generate data-access parameters for one or more groups and/or one or more access requests. In some embodiments, the data-access AI model includes a language model (“LM”) that may include an algorithm, rule, model, and/or other programmatic instructions that can predict the probability of a sequence of words or expressions (e.g., software code). In some embodiments, a language model may, given a starting text string (e.g., one or more words), predict the next word or expression in the sequence. In certain embodiments, a language model may calculate the probability of different word combinations and/or software code based on the patterns learned during training (based on a set of text data from books, articles, websites, audio files, software code, etc.).

In some embodiments, a language model may generate many combinations of one or more next words and/or expressions that are coherent and contextually relevant. In certain embodiments, a language model can be an advanced artificial intelligence algorithm that has been trained to understand, generate, and manipulate language (e.g., computing language expressions). In some embodiments, a language model can be useful for natural language processing, including receiving natural language prompts and providing natural language responses based on the text on which the model is trained. In certain embodiments, a language model may include an n-gram, exponential, positional, neural network, and/or other type of model. In some embodiments, a language model can be used to generate software code.

In certain embodiments, the data-access AI model includes a large language model (LLM), which was trained on a larger data set and has a larger number of parameters (e.g., billions of parameters) compared to a regular language model. In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pretrained Transformer 3 (GPT-3) model, a GPT 3.5-turbo model, a Claude model, a command-xlang model, a bidirectional encoder representations from transformers (BERT) model, a pathways language model (PaLM) 2, and/or the like.

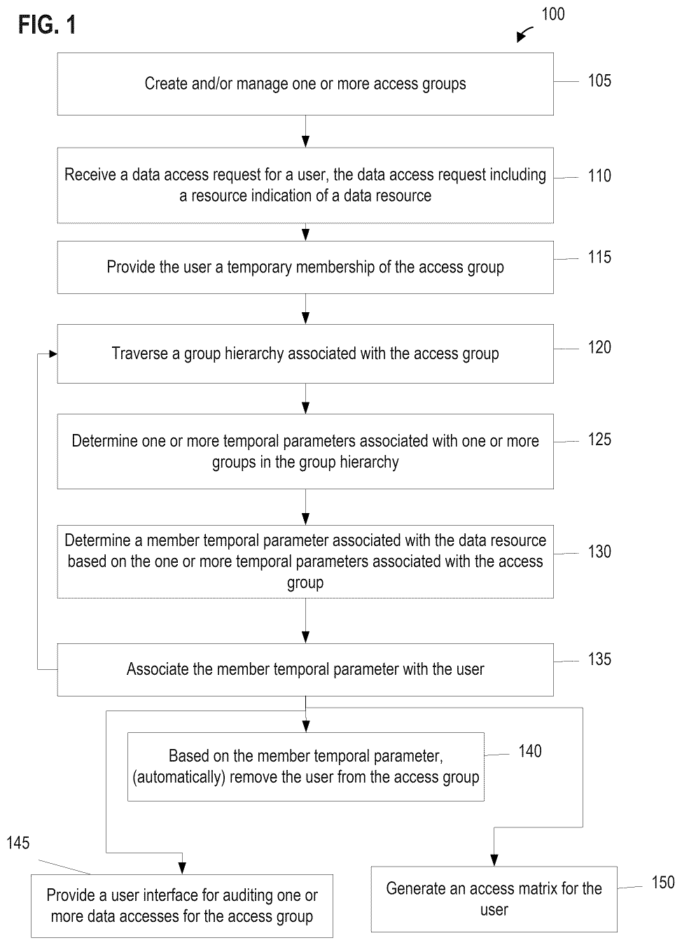

FIG. 1 is a simplified diagram showing a method 100 for managing data access according to certain embodiments of the present disclosure. This diagram is merely an example. One of ordinary skill in the art would recognize many variations, alternatives, and modifications. The method 100 for managing data access includes processes 105, 110, 115, 120, 125, 130, 135, 140, 145, and 150. Although the above has been shown using a selected group of processes for the method 100 for managing data access, there can be many alternatives, modifications, and variations. For example, some of the processes may be expanded and/or combined. Other processes may be inserted to those noted above. Depending upon the embodiment, the sequence of processes may be changed, and one or more processes may be replaced. Further details of these processes are found throughout the present disclosure.

In some embodiments, some or all processes (e.g., steps) of the method 100 are performed by a system (e.g., the computing system 800). In certain examples, some or all processes (e.g., steps) of the method 100 are performed by a computer and/or a processor directed by a code. For example, a computer includes a server computer and/or a client computer (e.g., a personal computer). In some examples, some or all processes (e.g., steps) of the method 100 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

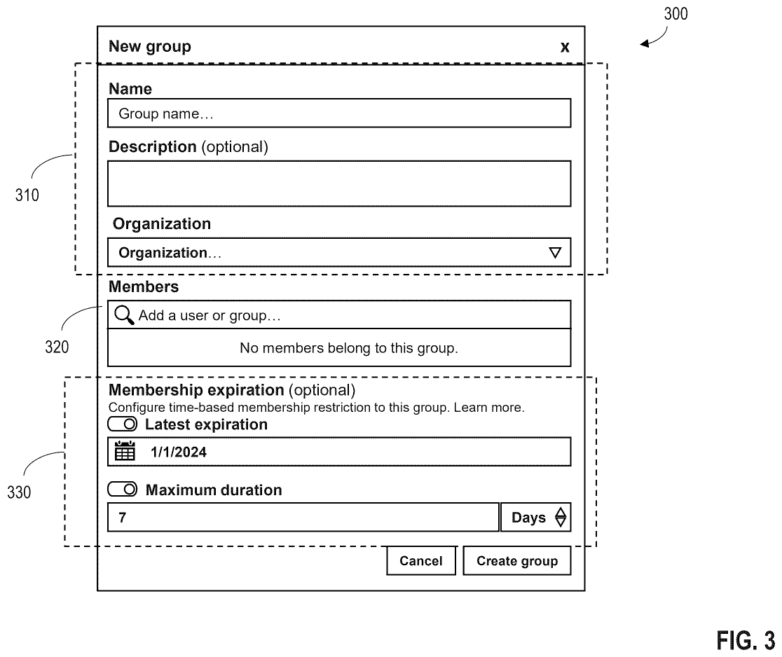

According to certain embodiments, at process 105, the system creates and/or manages (e.g., modifies, deletes, etc.) one or more access groups. In some embodiments, the system can use an access group to manage data accesses. In some embodiments, an access group includes one or more members, where each member can be a real user, a virtual user, an access group, and/or the like. FIG. 3 illustrates an example user interface 300 for creating and/or managing an access group according to certain embodiments of the present disclosure. FIG. 3 is merely an example, which should not unduly limit the scope of the claims. One of ordinary skill in the art would recognize many variations, alternatives, and modifications.

In this example, the user interface 300 includes a first UI section 310 for entering group information, a second UI section 320 for member information, and a third UI section 330 for one or more temporal parameters (e.g., time constraints). In some examples, the temporal parameters include a latest expiration in date and a maximum duration in a time unit (e.g., day) for the membership. In certain embodiments, the temporal parameters include two or more temporal parameters. In some embodiments, the system can receive at least one of the one or more temporal parameters via an interface (e.g., a user interface, a software interface). In certain embodiments, the system can determine at least one of the one or more temporal parameters that is implied and/or inherited. In some examples, the system can determine and/or compute an implied temporal parameter based on one or more other parameters. For example, an implied temporal parameter can be computed and/or determined based policy parameter and/or usage parameter (e.g., a project's end time). In certain examples, the system can determine an inherited temporal parameter based on a group hierarchy.

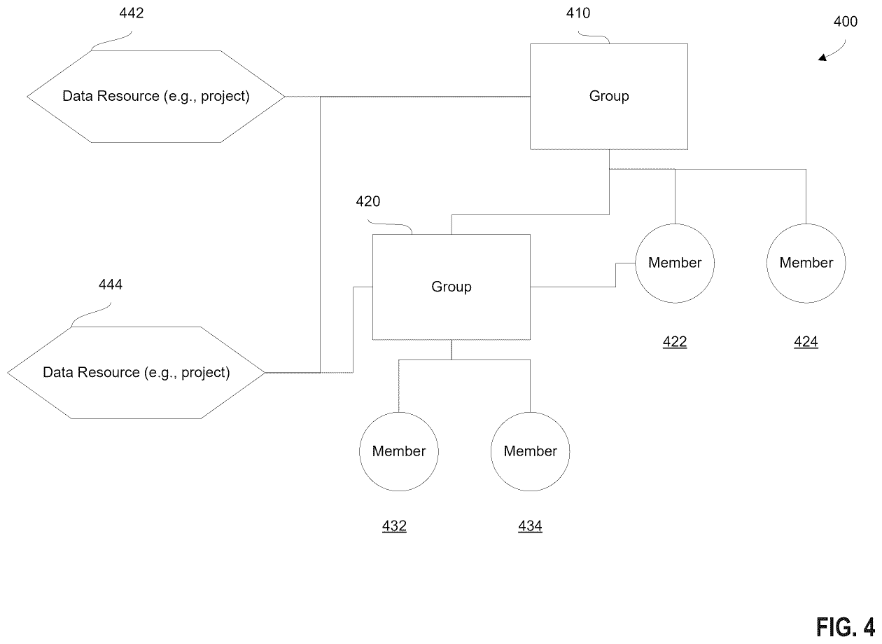

FIG. 4 illustrates an example set of entities 400 including groups, members, and data resources, according to certain embodiments of the present disclosure. FIG. 4 is merely an example, which should not unduly limit the scope of the claims. One of ordinary skill in the art would recognize many variations, alternatives, and modifications. For example, the set of entities 400 includes one or more groups (e.g., first group 410, second group 420), one or more members (422, 424, 432, 434, etc.) and one or more data resources (e.g., first data resource 442, second data resource 444). As an example, the group hierarchy includes a first group 410 as a parent group and a second group 420 as a child group. As an example, the first group 410, also referred to as the first access group 410, includes a plurality of first group members (422, 424, etc.) and the second group 420, also referred to as the second access group 420, includes a plurality of second group members (432, 434, etc.). In some embodiments, the second group 420 can inherit one or more temporal parameters from the first group 410, where the system can determine such inherited temporal parameters.

Referring back to FIG. 1, according to some embodiments, at process 110, the system receives a data access request for a user. In certain embodiments, the data access request includes a request to access a data resource. In some embodiments, the data access request includes a resource indication of the data resource. In certain embodiments, the data resource includes data from one or more data sources and/or data for one or more projects (e.g., a supply chain project, a healthcare supply chain project, a warehouse management project, etc.). In some embodiments, a project refers to a software and/or hardware application for an operation that generates, uses, modifies, and/or deletes data from one or more data sources (e.g., databases, data repositories, sensors, etc.). In certain embodiments, the data resource includes other resources associated with the one or more projects (e.g., software applications, etc.).

According to certain embodiments, the data access request includes one or more roles, also referred to predetermined accesses. In some embodiments, a predetermined access (e.g., a role) includes a discoverer, a viewer, an editor, an owner, and/or the like. For example, a discoverer can only see files' name and metadata, a viewer can view the content of files but cannot edit the files and cannot manage the files' security, an editor can edit the files and/or modify sharing property, and an owner can edit the files and has full control over the files' security. In certain embodiments, a first role has less access rights than a second role. In some embodiments, a first role has less access rights than a second role, the second role has less access rights than a third role. In certain embodiments, a first role has less access rights than a second role, the second role has less access rights than a third role, and the third role has less access rights than a fourth role.

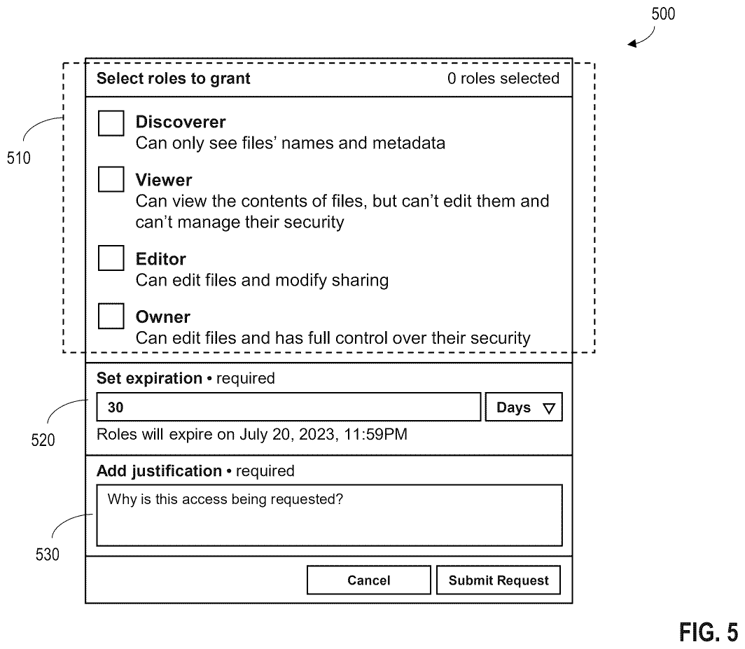

According to some embodiments, the data access request includes a temporal parameter. In certain embodiments, the data access request is required to include a temporal parameter. FIG. 5 is an example data access request 500 according to certain embodiments of the present disclosure. FIG. 5 is merely an example, which should not unduly limit the scope of the claims. One of ordinary skill in the art would recognize many variations, alternatives, and modifications. For example, the data access request 500 includes a role parameter 510, a temporal parameter 520, and a justification parameter 530. In certain embodiments, the data access request includes a group indication of an access group and a resource indication of a data resource.

According to certain embodiments, at process 115, the system provides the user a temporary membership of the access group. In some embodiments, via granting the membership, the user has access to one or more data resources. For example, the system assigns the user as a member of the access group with a temporal parameter. In some embodiments, the access group is selected from the one or more access group based on the group indication (e.g., a group identifier, a department, a project group, etc.). In certain embodiments, the access group is selected based on the data access request. In some embodiments, the access group is selected based on the group indication, the resource indication, the role parameter, the temporal parameter, the justification parameter, and/or the like.

According to some embodiments, at process 120, the system traverses a group hierarchy associated with the access group. In certain embodiments, the group hierarchy includes one or more groups (e.g., group members). In some embodiments, the group hierarchy includes two or more group members. In certain embodiments, at process 125, the system determines one or more temporal parameters for the one or more groups in the group hierarchy. In some embodiments, the system determines one or more temporal parameters and corresponding values for the one or more groups in the group hierarchy. In certain embodiments, the system determines at least one temporal parameter value for at least one temporal parameter associated with each group level in the group hierarchy. In some embodiments, the temporal parameter includes a membership duration, an access latest expiration, an access maximum duration, a membership maximum duration, a membership latest expiration, an access duration, and/or the like. In certain embodiments, the system obtains and/or determines a same temporal parameter for each group level in the group hierarchy.

According to certain embodiments, at process 130, the system determines a member temporal parameter associated with the data resource based at least in part on one or more temporal parameters associated with the access group and/or one or more group members in the group hierarchy. In some embodiments, the member temporal parameter is determined based at least in part on the temporal parameter in the data access request. In certain embodiments, the system sets a shortest duration and/or earliest date as the parameter value of the member temporal parameter based on the one or more temporal parameters associated with the access group and/or one or more group members in the group hierarchy. In some embodiments, the system selects a parameter type and/or a parameter value of the member temporal parameter.

Referring to FIG. 4, as an example, the user is granted temporary membership as member 434 to the second group 420, which is a child group of the first group 410. In some examples, the system determines and/or obtains a first temporal parameter of the first group 410 and its value associated with the second data resource 444. In certain examples, the system determines and/or obtains a second temporal parameter of the second group 420 and its value associated with the second data resource 444. In some examples, the system determines the member temporal parameter and the member temporal parameter value based on the first temporal parameter and the second temporal parameter, and the corresponding parameter values. For example, the first temporal parameter is the latest expiration and set to Jan. 1, 2025 and the second temporal parameter is the maximum duration and set to 30 days. In some examples, the system determines the member temporal parameter to be the latest expiration or the maximum duration. In certain examples, the system determines the member temporal parameter to be both the latest expiration and the maximum duration.

In some embodiments, the user 432 can access the data resource 444 via the first access group 410 with a first predetermined access and a first member temporal parameter. In certain embodiments, the user 432 can access the data resource 444 via the second access group 420 with a second predetermined access and a second member temporal parameter. In some embodiments, the first predetermined access is the same as the second predetermined access. In certain embodiments, the first predetermined access is different from the second predetermined access. In some embodiments, the first member temporal parameter is the same as the second member temporal parameter. In certain embodiments, the first member temporal parameter is different from the second member temporal parameter in a parameter type and/or a parameter value.

In some embodiments, an access group has access to a plurality of data resources. In some embodiments, an access group has predetermined access (e.g., of a role) to a plurality of data resources. In certain embodiments, a user (e.g., a real user, a virtual user, a group of users, etc.) is a member of a plurality of access groups. In some embodiments, a member has access to a data resource via a respective membership to a plurality of access groups. In certain embodiments, a member has a respective predetermined access (e.g., a viewer, an editor) to a data resource via a respective membership to a plurality of access groups. In an example illustrated in FIG. 4, the member 422 is a member of the first group 410 and a member of the second group 420, where both groups have access to the second data resource 444. In some examples, the member 422 has a first predetermined access to the second data resource 444 via the first group 410 and the member 422 has a second predetermined access to the second data resource 444 via the second group 420, where the first predetermined access (e.g., a viewer) is different from the second predetermined access (e.g., an owner). In some embodiments, the member 422 is assigned with a first member temporal parameter associated first data resource 442 and a second member temporal parameter associated with second data resource 444. In certain embodiments, the second member temporal parameter is different than the first member temporal parameter in a parameter type (e.g., duration or expiration) and/or a parameter value.

According to certain embodiments, the system can set values of member temporal parameters (e.g., time constraints) both via the access group (e.g., by a group administrator) and/or by the user requesting membership to the access group (e.g., asynchronously) and membership being granted, for example after approval from a group administrator. In some embodiments, the member temporal parameters (e.g., asynchronous membership requests) are capped by the implied temporal parameters (e.g., time constraints) and/or inherited temporal parameters (e.g., time constraints) set against the access group and/or one or more group members in the group hierarchy.

In certain embodiments, the system generates the member temporal parameter using a machine-learning model, referred to as a data-access AI model. In some embodiments, the system generates the member access parameter using the data-access AI model based at least in part on the access group, the data resource, the data access request, data access parameters of the access group and/or one or more group members in the group hierarchy, and the member temporal parameter. In certain embodiments, a data-access AI model can generate data access parameters (e.g., temporal parameters, predetermined accesses, roles, etc.) for members, groups, users, organizations, projects, and/or the like.

In some embodiments, the data-access AI model (e.g., a language model, an LLM, etc.) can be trained using selected corpus (e.g., historical access parameters, historical project data, historical group data, historical temporal parameters and values, historical predetermined accesses, etc.). In certain examples, a data-access AI model can include training data (e.g., a part of training corpus) embedded in the model. In some embodiments, the data-access AI model includes a generative AI (artificial intelligence) model with training data embedded in the model. In some examples, the data-access AI model is configured to generate data-access parameters for one or more groups and/or one or more access requests. In certain embodiments, using the temporal parameters (e.g., time-based membership, time-based conditions, etc.), the data access control can be improved, for example, compliance with time requirements. In some embodiments, using the access group to manage data access comes with the advantage of managing access to data with different levels of granularity (e.g., different time constraints, different access to data (view, edit, etc.)) at scale (e.g., across multiple systems).

According to some embodiments, at process 135, the system associates the member temporal parameter with the user. In certain embodiments, the system may change or receive a change to one or more temporal parameters of the access group and/or group members of the group hierarchy. In some embodiments, the system can update the member temporal parameter and its value corresponding to the change to one or more temporal parameters of the access group and/or group members. In certain embodiments, the system can go back to process 120 to update the member temporal parameter and its value. For example, referring to FIG. 4, the user is member 434 of the second group 420, which is a child group of the first group 410. As an example, the system can change a member temporal parameter associated with the member 434 when a change to a first temporal parameter (e.g., access duration) of the first group 410 and/or a second temporal parameter (e.g., latest expiration) of the second group 420 occurs.

According to certain embodiments, the system determines an expiration date for the user as a temporary member of the access group based on the member temporal parameter and its value. In some embodiments, at process 140, based on the member temporal parameter, the system removes the user from the access group (e.g., remove the membership). In some embodiments, based on the member temporal parameter, the system automatically removes the user from the access group (e.g., remove the membership).

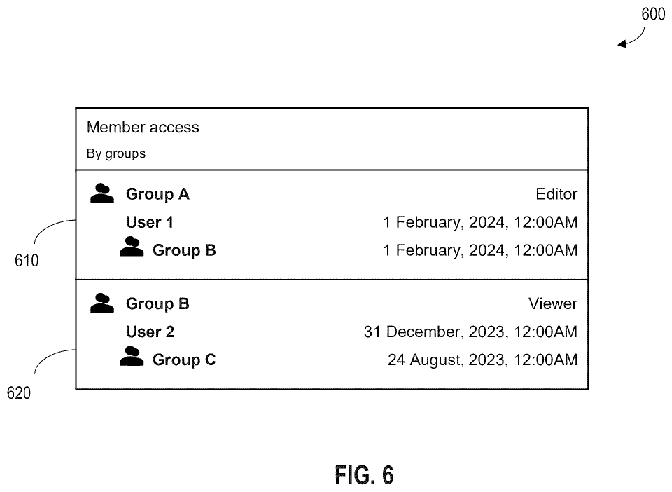

According to some embodiments, at process 145, the system provides a user interface for auditing one or more data accesses for the access group. In certain embodiments, the system audits a plurality of data accesses associated with a plurality of members in the access group. In some embodiments, the system determines a compliance to the temporal parameters of the access group and/or one or more group members in the group hierarchy for the plurality of members in the access group. In certain embodiments, the system determines compliance with the member temporal parameter and/or the temporal parameters of the access group and/or one or more group members in the group hierarchy for the user. FIG. 6 is an illustrative example of audit process 600 according to certain embodiments of the present disclosure. FIG. 6 is merely an example, which should not unduly limit the scope of the claims. One of ordinary skill in the art would recognize many variations, alternatives, and modifications. As an example, the audit process is to audit member access (e.g., by groups). For example, the audit process collects and presents first access information 610 for Group A and second access information 620 for Group B. As an example, the audit process includes the role information, the member information, the temporal parameter (e.g., when the membership will expire or has expired), and/or like.

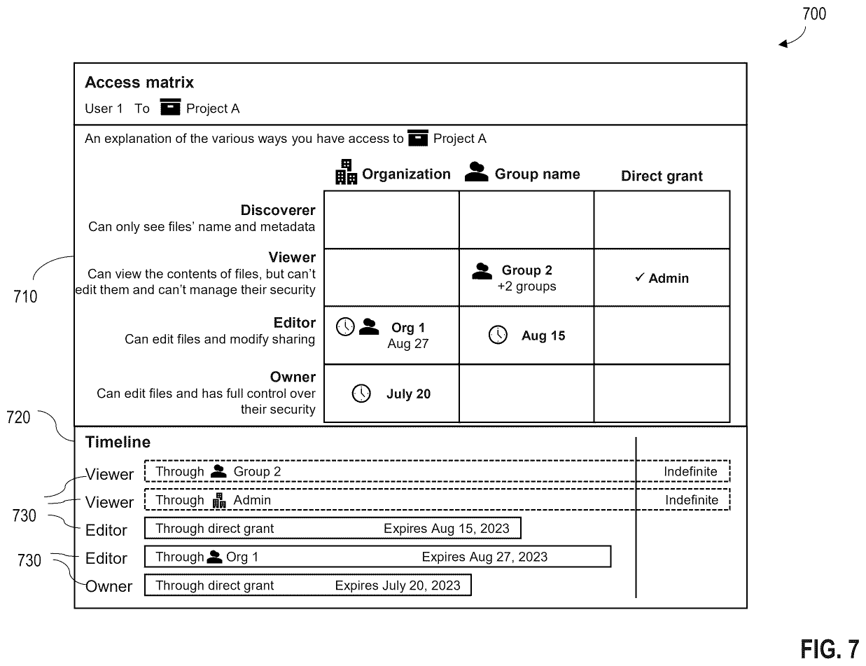

According to certain embodiments, at process 150, the system generates and/or presents an access matrix for the user. In some embodiments, the system generates and/or presents an access matrix for the access group. FIG. 7 is an illustrative example of an access matrix 700 according to certain embodiments of the present disclosure. FIG. 7 is merely an example, which should not unduly limit the scope of the claims. One of ordinary skill in the art would recognize many variations, alternatives, and modifications. For example, the access matrix 700 includes an explanation 710 of a plurality of predetermined accesses (e.g., roles) of a user (e.g., User 1) for a data resource (e.g., Project A). As an example, the access matrix 700 includes a timeline 720 of the timeline associated with the plurality of predetermined accesses for the User 1 in accessing Project A. In some examples, a user can have two or more predetermined accesses 730. In some examples, a user can have two or more predetermined accesses 730 set via different sources, for example, access group, organization, requested and granted, and/or the like. In certain examples, for a same predetermined access (e.g., editor), the user can have different temporal parameters and different parameter values. In some examples, for a same predetermined access (e.g., editor), the user can have different temporal parameters and different parameter values set via different sources, for example, access group, organization, requested and granted, and/or the like.

In certain embodiments, the system generates the access matrix, explanation, and/or timeline using a machine-learning model, also referred to as a matrix AI model. In some embodiments, the matrix AI model is different from the data access AI model. In certain embodiments, the system generates the access matrix, explanation, and/or timeline using the matrix AI model based at least in part on the access group, the data resource, the data access request, group hierarchy, data access parameters, temporal access parameters, and/or the like. In certain embodiments, the matrix AI model can generate data access parameters (e.g., temporal parameters, predetermined accesses, roles, etc.) for members, groups, users, organizations, projects, and/or the like.

In some embodiments, the matrix AI model (e.g., a language model, an LLM, etc.) can be trained using selected dataset (e.g., historical access parameters, historical project data, historical group data, historical temporal parameters and values, historical predetermined accesses, historical access matrixes, historical explanations, historical timelines etc.). In certain examples, the matrix AI model can include training data (e.g., a part of training corpus) embedded in the model. In some embodiments, the data-access AI model includes a generative AI (artificial intelligence) model with training data embedded in the model. In some examples, the matrix AI model is configured to generate a data-access explanation based at least in part on the access group, the resource, the data access request, one or more temporal parameters of the access group and/or group members in the group hierarchy, and the member temporal parameter, and/or the like.

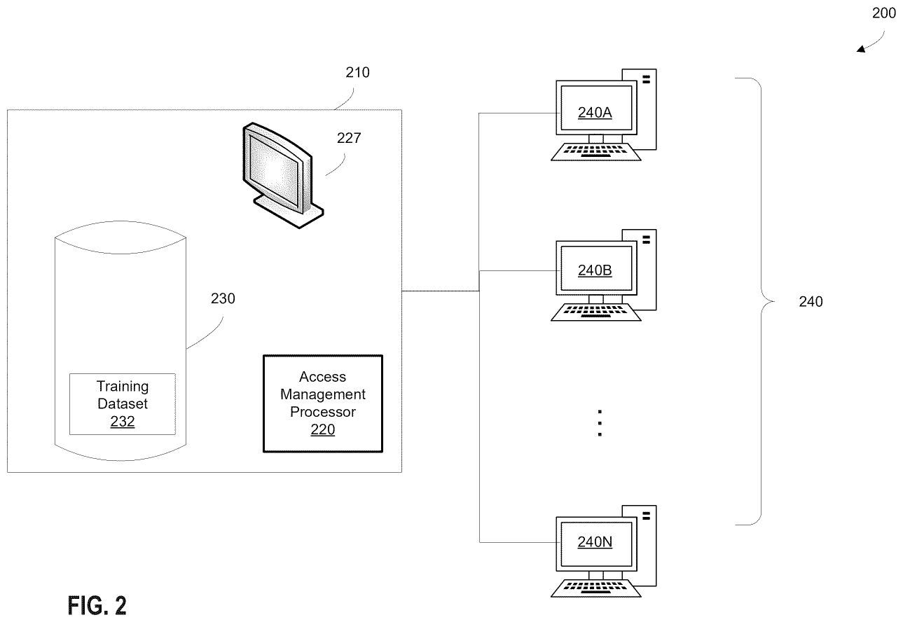

FIG. 2 is an illustrative data-access management environment 200 according to certain embodiments of the present disclosure. In some embodiments, the data-access management environment 200 includes one or more access management systems (e.g., data-access management software modules) 210 and one or more computing devices 240 (e.g., computing device 240A, computing device 240B, . . . computing device 240N, etc.). In certain embodiments, the access management system 210 includes one or more access management processors 220, one or more displays 227, and one or more data repositories 220. In some embodiments, the one or more data repositories 220 include one or more training datasets 232, for example, for one or more access AI models and/or one or more matrix AI models. In certain embodiments, the computing device 240 may include and/or access at least a part of the functionality of the data-access management system 210. Although the above has been shown using a selected group of components in the access management environment 200, there can be many alternatives, modifications, and variations. For example, some of the components may be expanded and/or combined. Other components may be inserted into those noted above. Depending upon the embodiment, the arrangement of components may be interchanged with others replaced. Further details of these components are found throughout the present disclosure.

According to certain embodiments, the access management system 210 (e.g., the access management processor 220, etc.) creates and/or manages (e.g., modifies, deletes, etc.) one or more access groups. In some embodiments, the access management system 210 (e.g., the access management processor 220, etc.) can use an access group to manage data accesses. In some embodiments, an access group includes one or more members, where each member can be a real user, a virtual user, an access group, and/or the like. FIG. 3 illustrates an example user interface 300 for creating and/or managing an access group according to certain embodiments of the present disclosure. FIG. 3 is merely an example, which should not unduly limit the scope of the claims. One of ordinary skill in the art would recognize many variations, alternatives, and modifications.

In this example, the user interface 300, for example, presented on the display 227 or a display of the computing device 240, includes a first UI section 310 for entering group information, a second UI section 320 for member information, and a third UI section 330 for one or more temporal parameters (e.g., time constraints). In some examples, the temporal parameters include a latest expiration in date and a maximum duration in a time unit (e.g., day) for the membership. In certain embodiments, the temporal parameters include two or more temporal parameters. In some embodiments, the access management system 210 (e.g., the access management processor 220, etc.) can receive at least one of the one or more temporal parameters via an interface (e.g., a user interface, a software interface). In certain embodiments, the access management system 210 (e.g., the access management processor 220, etc.) can determine at least one of the one or more temporal parameters that is implied and/or inherited. In some examples, the access management system 210 (e.g., the access management processor 220, etc.) can determine and/or compute an implied temporal parameter based on one or more other parameters. For example, an implied temporal parameter can be computed and/or determined based policy parameter and/or usage parameter (e.g., a project's end time). In certain examples, the access management system 210 (e.g., the access management processor 220, etc.) can determine an inherited temporal parameter based on a group hierarchy.

FIG. 4 illustrates an example set of entities 400 including groups, members, and data resources, according to certain embodiments of the present disclosure. FIG. 4 is merely an example, which should not unduly limit the scope of the claims. One of ordinary skill in the art would recognize many variations, alternatives, and modifications. For example, the set of entities 400 includes one or more groups (e.g., first group 410, second group 420), one or more members (422, 424, 432, 434, etc.) and one or more data resources (e.g., first data resource 442, second data resource 444). As an example, the group hierarchy includes a first group 410 as a parent group and a second group 420 as a child group. As an example, the first group 410 includes a plurality of first group members (422, 424, etc.) and the second group 420 includes a plurality of second group members (432, 434, etc.). In some embodiments, the second group 420 can inherit one or more temporal parameters from the first group 410, where the access management system 210 (e.g., the access management processor 220, etc.) can determine such inherited temporal parameters.

According to some embodiments, the access management system 210 (e.g., the access management processor 220, etc.) receives a data access request for a user. In certain embodiments, the data access request includes a request to access a data resource. In some embodiments, the data access request includes a resource indication of the data resource. In certain embodiments, the data resource includes data from one or more data sources and/or data for one or more projects (e.g., a supply chain project, a healthcare supply chain project, a warehouse management project, etc.). In some embodiments, a project refers to a software and/or hardware application for an operation that generates, uses, modifies, and/or deletes data from one or more data sources (e.g., databases, data repositories, sensors, etc.). In certain embodiments, the data resource includes other resources associated with the one or more projects (e.g., software applications, etc.).

According to certain embodiments, the data access request includes one or more roles, also referred to predetermined accesses. In some embodiments, a predetermined access (e.g., a role) includes a discoverer, a viewer, an editor, an owner, and/or the like. For example, a discoverer can only see files' name and metadata, a viewer can view the content of files but cannot edit the files and cannot manage the files' security, an editor can edit the files and/or modify sharing property, and an owner can edit the files and has full control over the files' security. In certain embodiments, a first role has less access rights than a second role. In some embodiments, a first role has less access rights than a second role, the second role has less access rights than a third role. In certain embodiments, a first role has less access rights than a second role, the second role has less access rights than a third role, and the third role has less access rights than a fourth role.

According to some embodiments, the data access request includes a temporal parameter. In certain embodiments, the data access request is required to include a temporal parameter. FIG. 5 is an example data access request 500 according to certain embodiments of the present disclosure. FIG. 5 is merely an example, which should not unduly limit the scope of the claims. One of ordinary skill in the art would recognize many variations, alternatives, and modifications. For example, the data access request 500 includes a role parameter 510, a temporal parameter 520, and a justification parameter 530. In certain embodiments, the data access request includes a group indication of an access group and a resource indication of a data resource.

According to certain embodiments, the access management system 210 (e.g., the access management processor 220, etc.) provides the user a temporary membership of the access group. In some embodiments, via granting the membership, the user has access to one or more data resources. For example, the access management system 210 (e.g., the access management processor 220, etc.) assigns the user as a member of the access group with a temporal parameter. In some embodiments, the access group is selected from the one or more access group based on the group indication (e.g., a group identifier, a department, a project group, etc.). In certain embodiments, the access group is selected based on the data access request. In some embodiments, the access group is selected based on the group indication, the resource indication, the role parameter, the temporal parameter, the justification parameter, and/or the like.

According to some embodiments, the access management system 210 (e.g., the access management processor 220, etc.) traverses a group hierarchy associated with the access group. In certain embodiments, the group hierarchy includes one or more groups (e.g., group members). In some embodiments, the group hierarchy includes two or more group members. In certain embodiments, the access management system 210 (e.g., the access management processor 220, etc.) determines one or more temporal parameters for the one or more groups in the group hierarchy. In some embodiments, the access management system 210 (e.g., the access management processor 220, etc.) determines one or more temporal parameters and corresponding values for the one or more groups in the group hierarchy. In certain embodiments, the access management system 210 (e.g., the access management processor 220, etc.) determines at least one temporal parameter value for at least one temporal parameter associated with each group level in the group hierarchy. In some embodiments, the temporal parameter includes a membership duration, an access latest expiration, an access maximum duration, a membership maximum duration, a membership latest expiration, an access duration, and/or the like. In certain embodiments, the access management system 210 (e.g., the access management processor 220, etc.) obtains and/or determines a same temporal parameter for each group level in the group hierarchy.

According to certain embodiments, the access management system 210 (e.g., the access management processor 220, etc.) determines a member temporal parameter associated with the data resource based at least in part on one or more temporal parameters associated with the access group and/or one or more group members in the group hierarchy. In some embodiments, the member temporal parameter is determined based at least in part on the temporal parameter in the data access request. In certain embodiments, the access management system 210 (e.g., the access management processor 220, etc.) sets a shortest duration and/or earliest date as the parameter value of the member temporal parameter based on the one or more temporal parameters associated with the access group and/or one or more group members in the group hierarchy. In some embodiments, the system selects a parameter type and/or a parameter value of the member temporal parameter.

Referring to FIG. 4, as an example, the user is granted temporary membership as member 434 to the second group 420, which is a child group of the first group 410. In some examples, the access management system 210 (e.g., the access management processor 220, etc.) determines and/or obtains a first temporal parameter of the first group 410 and its value associated with the second data resource 444. In certain examples, the access management system 210 (e.g., the access management processor 220, etc.) determines and/or obtains a second temporal parameter of the second group 420 and its value associated with the second data resource 444. In some examples, the access management system 210 (e.g., the access management processor 220, etc.) determines the member temporal parameter and the member temporal parameter value based on the first temporal parameter and the second temporal parameter, and the corresponding parameter values. For example, the first temporal parameter is the latest expiration and set to Jan. 1, 2025 and the second temporal parameter is the maximum duration and set to 30 days. In some examples, the access management system 210 (e.g., the access management processor 220, etc.) determines the member temporal parameter to be the latest expiration or the maximum duration. In certain examples, the access management system 210 (e.g., the access management processor 220, etc.) determines the member temporal parameter to be both the latest expiration and the maximum duration.

In some embodiments, the user 432 can access the data resource 444 via the first group 410 with a first predetermined access and a first member temporal parameter. In certain embodiments, the user 432 can access the data resource 444 via the second group 420 with a second predetermined access and a second member temporal parameter. In some embodiments, the first predetermined access is the same as the second predetermined access. In certain embodiments, the first predetermined access is different from the second predetermined access. In some embodiments, the first member temporal parameter is the same as the second member temporal parameter. In certain embodiments, the first member temporal parameter is different from the second member temporal parameter in a parameter type and/or a parameter value.

In some embodiments, an access group has access to a plurality of data resources. In some embodiments, an access group has predetermined access (e.g., of a role) to a plurality of data resources. In certain embodiments, a user (e.g., a real user, a virtual user, a group of users, etc.) is a member of a plurality of access groups. In some embodiments, a member has access to a data resource via a respective membership to a plurality of access groups. In certain embodiments, a member has a respective predetermined access (e.g., a viewer, an editor) to a data resource via a respective membership to a plurality of access groups. In an example illustrated in FIG. 4, the member 422 is a member of the first group 410 and a member of the second group 420, where both groups have access to the second data resource 444. In some examples, the member 422 has a first predetermined access to the second data resource 444 via the first group 410 and the member 422 has a second predetermined access to the second data resource 444 via the second group 420, where the first predetermined access (e.g., a viewer) is different from the second predetermined access (e.g., an owner). In some embodiments, the member 422 is assigned with a first member temporal parameter associated first data resource 442 and a second member temporal parameter associated with second data resource 444. In certain embodiments, the second member temporal parameter is different than the first member temporal parameter in a parameter type (e.g., duration or expiration) and/or a parameter value.

According to certain embodiments, the access management system 210 (e.g., the access management processor 220, etc.) can set values of member temporal parameters (e.g., time constraints) both via the access group (e.g., by a group administrator) and/or by the user requesting membership to the access group (e.g., asynchronously) and membership being granted, for example after approval from a group administrator. In some embodiments, the member temporal parameters (e.g., asynchronous membership requests) are capped by the implied temporal parameters (e.g., time constraints) and/or inherited temporal parameters (e.g., time constraints) set against the access group and/or one or more group members in the group hierarchy.

In certain embodiments, the access management system 210 (e.g., the access management processor 220, etc.) generates the member temporal parameter using a machine-learning model, referred to as a data-access AI model. In some embodiments, the access management system 210 (e.g., the access management processor 220, etc.) generates the member access parameter using the data-access AI model based at least in part on the access group, the data resource, the data access request, data access parameters of the access group and/or one or more group members in the group hierarchy, and the member temporal parameter. In certain embodiments, a data-access AI model can generate data access parameters (e.g., temporal parameters, predetermined accesses, roles, etc.) for members, groups, users, organizations, projects, and/or the like.

In some embodiments, the data-access AI model (e.g., a language model, an LLM, etc.) can be trained using selected corpus (e.g., historical access parameters, historical project data, historical group data, historical temporal parameters and values, historical predetermined accesses, etc.). In certain examples, a data-access AI model can include training data (e.g., a part of training dataset 232) embedded in the model. In some embodiments, the data-access AI model includes a generative AI (artificial intelligence) model with training data embedded in the model. In some examples, the data-access AI model is configured to generate data-access parameters for one or more groups and/or one or more access requests. In certain embodiments, using the temporal parameters (e.g., time-based membership, time-based conditions, etc.), the data access control can be improved, for example, compliance with time requirements. In some embodiments, using the access group to manage data access comes with the advantage of managing access to data with different levels of granularity (e.g., different time constraints, different access to data (view, edit, etc.)) at scale (e.g., across multiple systems).

According to some embodiments, the access management system 210 (e.g., the access management processor 220, etc.) associates the member temporal parameter with the user. In certain embodiments, the access management system 210 (e.g., the access management processor 220, etc.) may change or receive a change to one or more temporal parameters of the access group and/or group members of the group hierarchy. In some embodiments, the access management system 210 (e.g., the access management processor 220, etc.) can update the member temporal parameter and its value corresponding to the change to the one or more temporal parameters of the access group and/or group members. For example, referring to FIG. 4, the user is member 434 of the second group 420, which is a child group of the first group 410. As an example, the access management system 210 (e.g., the access management processor 220, etc.) can change a member temporal parameter associated with the member 434 when a change to a first temporal parameter (e.g., access duration) of the first group 410 and/or a second temporal parameter (e.g., latest expiration) of the second group 420 occurs.

According to certain embodiments, the access management system 210 (e.g., the access management processor 220, etc.) determines an expiration date for the user as a temporary member of the access group based on the member temporal parameter and its value. In some embodiments, based on the member temporal parameter, the access management system 210 (e.g., the access management processor 220, etc.) removes the user from the access group (e.g., remove the membership). In some embodiments, based on the member temporal parameter, the access management system 210 (e.g., the access management processor 220, etc.) automatically removes the user from the access group (e.g., remove the membership).

According to some embodiments, the access management system 210 (e.g., the access management processor 220, etc.) provides a user interface for auditing one or more data accesses for the access group. In certain embodiments, the access management system 210 (e.g., the access management processor 220, etc.) audits a plurality of data accesses associated with a plurality of members in the access group. In some embodiments, the access management system 210 (e.g., the access management processor 220, etc.) determines a compliance to the temporal parameters of the access group and/or one or more group members in the group hierarchy for the plurality of members in the access group. In certain embodiments, the access management system 210 (e.g., the access management processor 220, etc.) determines compliance with the member temporal parameter and/or the temporal parameters of the access group and/or one or more group members in the group hierarchy for the user. FIG. 6 is an illustrative example of audit process 600 according to certain embodiments of the present disclosure. FIG. 6 is merely an example, which should not unduly limit the scope of the claims. One of ordinary skill in the art would recognize many variations, alternatives, and modifications. As an example, the audit process is to audit member access (e.g., by groups). For example, the audit process collects and presents first access information 610 for Group A and second access information 620 for Group B. As an example, the audit process includes determining compliance using the role information, the member information, the temporal parameter (e.g., when the membership will expire or has expired), and/or like.

According to certain embodiments, the access management system 210 (e.g., the access management processor 220, etc.) generates and/or presents an access matrix for the user. In some embodiments, the access management system 210 (e.g., the access management processor 220, etc.) generates and/or presents (e.g., on the display 227, on the computing device 240, etc.) an access matrix for the access group. FIG. 7 is an illustrative example of an access matrix 700 according to certain embodiments of the present disclosure. FIG. 7 is merely an example, which should not unduly limit the scope of the claims. One of ordinary skill in the art would recognize many variations, alternatives, and modifications. For example, the access matrix 700 includes an explanation 710 of a plurality of predetermined accesses (e.g., roles) of a user (e.g., User 1) for a data resource (e.g., Project A). As an example, the access matrix 700 includes a timeline 720 of the timeline associated with the plurality of predetermined accesses for the User 1 in accessing Project A. In some examples, a user can have two or more predetermined accesses 730. In some examples, a user can have two or more predetermined accesses 730 set via different sources, for example, access group, organization, requested and granted, and/or the like. In certain examples, for a same predetermined access (e.g., editor), the user can have different temporal parameters and different parameter values. In some examples, for a same predetermined access (e.g., editor), the user can have different temporal parameters and different parameter values set via different sources, for example, access group, organization, requested and granted, and/or the like.

In certain embodiments, the access management system 210 (e.g., the access management processor 220, etc.) generates the access matrix, explanation, and/or timeline using a machine-learning model, also referred to as a matrix AI model. In some embodiments, the matrix AI model is different from the data access AI model. In certain embodiments, the access management system 210 (e.g., the access management processor 220, etc.) generates the access matrix, explanation, and/or timeline using the matrix AI model based at least in part on the access group, the data resource, the data access request, group hierarchy, data access parameters, temporal access parameters, and/or the like. In certain embodiments, the matrix AI model can generate data access parameters (e.g., temporal parameters, predetermined accesses, roles, etc.) for members, groups, users, organizations, projects, and/or the like.

In some embodiments, the matrix AI model (e.g., a language model, an LLM, etc.) can be trained using selected dataset (e.g., historical access parameters, historical project data, historical group data, historical temporal parameters and values, historical predetermined accesses, historical access matrixes, historical explanations, historical timelines etc.). In certain examples, the matrix AI model can include training data (e.g., a part of training corpus) embedded in the model. In some embodiments, the data-access AI model includes a generative AI (artificial intelligence) model with training data embedded in the model. In some examples, the matrix AI model is configured to generate a data-access explanation based at least in part on the access group, the resource, the data access request, one or more temporal parameters of the access group and/or group members in the group hierarchy, and the member temporal parameter, and/or the like.

In some embodiments, the one or more repositories 230 can include one or more training datasets 232, one or more access AI models, parameters and weight values for the one or more access AI models, one or more matrix AI models, data resource information, temporal parameters, data access parameters, access group information, group hierarchy information, and/or the like. The repository may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components in the access management environment 200 can execute software or firmware stored in non-transitory computer-readable medium to implement various processing steps. Various components and processors of the access management environment 200 can be implemented by one or more computing devices including, but not limited to, circuits, a computer, a cloud-based processing unit, a processor, a processing unit, a microprocessor, a mobile computing device, and/or a tablet computer. In some cases, various components of the access management environment 200 (e.g., the one or more access management systems 210, the one or more access management processors 220, the one or more computing devices 240) can be implemented on a shared computing device. Alternatively, a component of the operating environment 300 can be implemented on multiple computing devices. In some implementations, various modules and components of the access management environment 200 can be implemented as software, hardware, firmware, or a combination thereof. In some cases, various components of the access management environment 200 can be implemented in software or firmware executed by a computing device.

Various components of access management environment 200 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

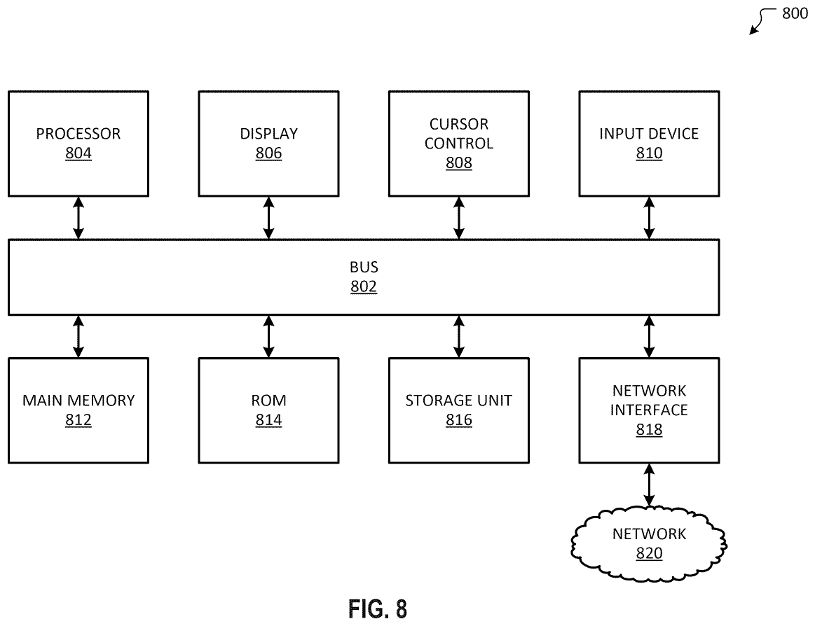

FIG. 8 is a simplified diagram showing a computing system for implementing a system 800 for data-access management in accordance with at least one example set forth in the disclosure. This diagram is merely an example, which should not unduly limit the scope of the claims. One of ordinary skill in the art would recognize many variations, alternatives, and modifications.

The computing system 800 includes a bus 802 or other communication mechanism for communicating information, a processor 804, a display 806, a cursor control component 808, an input device 810, a main memory 812, a read only memory (ROM) 814, a storage unit 816, and a network interface 818. In some embodiments, some or all processes (e.g., steps) of the methods (e.g., the method 100) and processes described in the present disclosure are performed by the computing system 800. In some examples, the bus 802 is coupled to the processor 804, the display 806, the cursor control component 808, the input device 810, the main memory 812, the read only memory (ROM) 814, the storage unit 816, and/or the network interface 818. In certain examples, the network interface is coupled to a network 820. For example, the processor 804 includes one or more general purpose microprocessors. In some examples, the main memory 812 (e.g., random access memory (RAM), cache and/or other dynamic storage devices) is configured to store information and instructions to be executed by the processor 804. In certain examples, the main memory 812 is configured to store temporary variables or other intermediate information during execution of instructions to be executed by processor 804. For example, the instructions, when stored in the storage unit 816 accessible to processor 804, render the computing system 800 into a special-purpose machine that is customized to perform the operations specified in the instructions. In some examples, the ROM 814 is configured to store static information and instructions for the processor 804. In certain examples, the storage unit 816 (e.g., a magnetic disk, optical disk, or flash drive) is configured to store information and instructions.

In some embodiments, the display 806 (e.g., a cathode ray tube (CRT), an LCD display, or a touch screen) is configured to display information to a user of the computing system 800. In some examples, the input device 810 (e.g., alphanumeric and other keys) is configured to communicate information and commands to the processor 804. For example, the cursor control component 808 (e.g., a mouse, a trackball, or cursor direction keys) is configured to communicate additional information and commands (e.g., to control cursor movements on the display 806) to the processor 804.

According to certain embodiments, a method for method for managing data access, the method comprising: receiving a data access request for a user, the data access request including a resource indication of a data resource; providing the user a membership of an access group associated with the data resource; determining a member temporal parameter associated with the data resource based on one or more temporal parameters associated with the access group; and associating the member temporal parameter with the user; wherein the method is performed by one or more processors. For example, the method is implemented according to at least FIG. 1, FIG. 2, FIG. 3, FIG. 4, FIG. 5, FIG. 6, and/or FIG. 7.

In some embodiments, the one or more temporal parameters associated with the access group include at least one selected from a group consisting of an access duration, an access latest expiration, an access maximum duration, and an access duration. the one or more temporal parameters include a first temporal parameter and a second temporal parameter, wherein the first temporal parameter is different from the second temporal parameter, wherein the member temporal parameter is the first temporal parameter and the second temporal parameter. In certain embodiments, the one or more temporal parameters include a first temporal parameter and a second temporal parameter; wherein the first temporal parameter is different from the second temporal parameter, wherein the first temporal parameter is set to a first time value and the second temporal parameter is set to a second time value; wherein the determining a member temporal parameter includes: determining a specific time value based on the first time value and the second time value; and set the specific time value to the member temporal parameter. the specific time value is an earlier time value between the first time value and the second time value.

In certain embodiments, the determining a member temporal parameter includes: traversing a group hierarchy associated with the access group, the group hierarchy including a plurality of groups; determining one or more temporal parameters associated with the plurality of the groups; and determining the time constraint based at least in part on the time constraint for the each level. In some embodiments, the data resource is a first data resource and the member temporal parameter is a first member temporal parameter; wherein the method further comprises: determining a second member temporal parameter associated with a second data resource different from the first data resource; wherein the second member temporal parameter is different than the first member temporal parameter in a parameter type and/or a parameter value.

In certain embodiments, the member temporal parameter is associated with a first predetermined access; wherein the member temporal parameter has a first time value associated with the first predetermined access of the user; wherein the method further comprises: determining a second time value associated with a second predetermined access of the user for the member temporal parameter, the second predetermined access being different from the first predetermined access, the second time value being different from the first time value. In some embodiments, the method further comprises: auditing a plurality of data accesses associated with a plurality of members in the group; and determining a compliance to the plurality of data accesses for the plurality of members in the group. the data access request includes a time-based value; wherein the determining a member temporal parameter for the user includes determining the member temporal parameter based at least in part on the time-based value. In certain embodiments, the access group is a first access group and the member temporal parameter is a first member temporal parameter, wherein the method further comprises: determining a second member temporal parameter for the user associated with a second access group different from the first access group; wherein the second member temporal parameter is different than the first member temporal parameter in a parameter type and/or a parameter value.

According to some embodiments, a system for managing data access, the system comprising: one or more memories comprising instructions stored thereon; and one or more processors configured to execute the instructions and perform operations comprising: receiving a data access request for a user, the data access request including a resource indication of a data resource; providing the user a membership of an access group associated with the data resource; determining a member temporal parameter associated with the data resource based on one or more temporal parameters associated with the access group; and associating the member temporal parameter with the user. For example, the system is implemented according to at least FIG. 1, FIG. 2, FIG. 3, FIG. 4, FIG. 5, FIG. 6, and/or FIG. 7.

In some embodiments, the one or more temporal parameters associated with the access group include at least one selected from a group consisting of an access duration, an access latest expiration, an access maximum duration, and an access duration. the one or more temporal parameters include a first temporal parameter and a second temporal parameter, wherein the first temporal parameter is different from the second temporal parameter, wherein the member temporal parameter is the first temporal parameter and the second temporal parameter. In certain embodiments, the one or more temporal parameters include a first temporal parameter and a second temporal parameter; wherein the first temporal parameter is different from the second temporal parameter, wherein the first temporal parameter is set to a first time value and the second temporal parameter is set to a second time value; wherein the determining a member temporal parameter includes: determining a specific time value based on the first time value and the second time value; and set the specific time value to the member temporal parameter. the specific time value is an earlier time value between the first time value and the second time value.

In certain embodiments, the determining a member temporal parameter includes: traversing a group hierarchy associated with the access group, the group hierarchy including a plurality of groups; determining one or more temporal parameters associated with the plurality of the groups; and determining the time constraint based at least in part on the time constraint for the each level. In some embodiments, the data resource is a first data resource and the member temporal parameter is a first member temporal parameter; wherein the operations further comprise: determining a second member temporal parameter associated with a second data resource different from the first data resource; wherein the second member temporal parameter is different than the first member temporal parameter in a parameter type and/or a parameter value.

In certain embodiments, the member temporal parameter is associated with a first predetermined access; wherein the member temporal parameter has a first time value associated with the first predetermined access of the user; wherein the operations further comprise: determining a second time value associated with a second predetermined access of the user for the member temporal parameter, the second predetermined access being different from the first predetermined access, the second time value being different from the first time value. In some embodiments, the operations further comprise: auditing a plurality of data accesses associated with a plurality of members in the group; and determining a compliance to the plurality of data accesses for the plurality of members in the group. the data access request includes a time-based value; wherein the determining a member temporal parameter for the user includes determining the member temporal parameter based at least in part on the time-based value. In certain embodiments, the access group is a first access group and the member temporal parameter is a first member temporal parameter, wherein the operations further comprise: determining a second member temporal parameter for the user associated with a second access group different from the first access group; wherein the second member temporal parameter is different than the first member temporal parameter in a parameter type and/or a parameter value.

According to certain embodiments, a non-transitory computer-readable storage medium having instructions for managing data access that, when executed by one or more processors, cause the one or more processors to perform operations comprising: receiving a data access request for a user, the data access request including a resource indication of a data resource; providing the user a membership of an access group associated with the data resource; determining a member temporal parameter associated with the data resource based on one or more temporal parameters associated with the access group; and associating the member temporal parameter with the user. For example, the non-transitory computer-readable storage medium is implemented according to at least FIG. 1, FIG. 2, FIG. 3, FIG. 4, FIG. 5, FIG. 6, and/or FIG. 7.

In some embodiments, the one or more temporal parameters associated with the access group include at least one selected from a group consisting of an access duration, an access latest expiration, an access maximum duration, and an access duration. the one or more temporal parameters include a first temporal parameter and a second temporal parameter, wherein the first temporal parameter is different from the second temporal parameter, wherein the member temporal parameter is the first temporal parameter and the second temporal parameter. In certain embodiments, the one or more temporal parameters include a first temporal parameter and a second temporal parameter; wherein the first temporal parameter is different from the second temporal parameter, wherein the first temporal parameter is set to a first time value and the second temporal parameter is set to a second time value; wherein the determining a member temporal parameter includes: determining a specific time value based on the first time value and the second time value; and set the specific time value to the member temporal parameter. the specific time value is an earlier time value between the first time value and the second time value.

In certain embodiments, the determining a member temporal parameter includes: traversing a group hierarchy associated with the access group, the group hierarchy including a plurality of groups; determining one or more temporal parameters associated with the plurality of the groups; and determining the time constraint based at least in part on the time constraint for the each level. In some embodiments, the data resource is a first data resource and the member temporal parameter is a first member temporal parameter; wherein the operations further comprise: determining a second member temporal parameter associated with a second data resource different from the first data resource; wherein the second member temporal parameter is different than the first member temporal parameter in a parameter type and/or a parameter value.

In certain embodiments, the member temporal parameter is associated with a first predetermined access; wherein the member temporal parameter has a first time value associated with the first predetermined access of the user; wherein the operations further comprise: determining a second time value associated with a second predetermined access of the user for the member temporal parameter, the second predetermined access being different from the first predetermined access, the second time value being different from the first time value. In some embodiments, the operations further comprise: auditing a plurality of data accesses associated with a plurality of members in the group; and determining a compliance to the plurality of data accesses for the plurality of members in the group. the data access request includes a time-based value; wherein the determining a member temporal parameter for the user includes determining the member temporal parameter based at least in part on the time-based value. In certain embodiments, the access group is a first access group and the member temporal parameter is a first member temporal parameter, wherein the operations further comprise: determining a second member temporal parameter for the user associated with a second access group different from the first access group; wherein the second member temporal parameter is different than the first member temporal parameter in a parameter type and/or a parameter value.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for managing data access, the method comprising:
receiving a data access request for a user, the data access request including a resource indication of a data resource;
providing the user a membership of an access group associated with the data resource;
determining a member temporal parameter associated with the data resource based on one or more temporal parameters associated with the access group; and
associating the member temporal parameter with the user;
wherein the method is performed by one or more processors.

2. The method of claim 1, wherein the one or more temporal parameters associated with the access group include at least one selected from a group consisting of an access duration, an access latest expiration, an access maximum duration, a membership duration, an access expiration, a membership expiration, and a membership maximum duration.

3. The method of claim 1, wherein the one or more temporal parameters include a first temporal parameter and a second temporal parameter, wherein the first temporal parameter is different from the second temporal parameter, wherein the member temporal parameter is the first temporal parameter and the second temporal parameter.

4. The method of claim 1, wherein the one or more temporal parameters include a first temporal parameter and a second temporal parameter;
wherein the first temporal parameter is different from the second temporal parameter, wherein the first temporal parameter is set to a first time value and the second temporal parameter is set to a second time value;
wherein the determining a member temporal parameter includes:
determining a specific time value based on the first time value and the second time value; and
set the specific time value to the member temporal parameter.

5. The method of claim 4, wherein the specific time value is an earlier time value between the first time value and the second time value.

6. The method of claim 1, wherein the determining a member temporal parameter includes:
traversing a group hierarchy associated with the access group, the group hierarchy including a plurality of groups, the plurality of groups including the access group;
determining one or more temporal parameters associated with the plurality of groups; and
determining the member temporal parameter based at least in part on the one or more temporal parameters associated with the plurality of groups.

7. The method of claim 1, wherein the data resource is a first data resource and the member temporal parameter is a first member temporal parameter;
wherein the method further comprises:
determining a second member temporal parameter associated with a second data resource different from the first data resource;
wherein the second member temporal parameter is different than the first member temporal parameter in a parameter type and/or a parameter value.

8. The method of claim 1, wherein the member temporal parameter is associated with a first predetermined access;
wherein the member temporal parameter has a first time value associated with the first predetermined access of the user;
wherein the method further comprises:
determining a second time value associated with a second predetermined access of the user for the member temporal parameter, the second predetermined access being different from the first predetermined access, the second time value being different from the first time value.

9. The method of claim 1, further comprising:
auditing a plurality of data accesses associated with a plurality of members in the access group; and
determining a compliance to the plurality of data accesses for the plurality of members in the access group.

10. The method of claim 1, wherein the data access request includes a time-based value;
wherein the determining a member temporal parameter for the user includes determining the member temporal parameter based at least in part on the time-based value.

11. The method of claim 1, wherein the access group is a first access group and the member temporal parameter is a first member temporal parameter, wherein the method further comprises:
determining a second member temporal parameter for the user associated with a second access group different from the first access group;
wherein the second member temporal parameter is different than the first member temporal parameter in a parameter type and/or a parameter value.

12. The method of claim 1, wherein the determining a member temporal parameter includes:
determining the member temporal parameter using a machine-learning model based at least in part on at least one selected from a group consisting of the access group, the data resource, one or more temporal parameters associated with the access group, and the data access request.

13. The method of claim 12, wherein the machine-learning model includes a large language model.

14. The method of claim 1, further comprising:
generating an access explanation using a machine-learning model based at least in part on at least one selected from a group consisting of the access group, the data resource, the data access request, and the member temporal parameter.

15. The method of claim 14, wherein the machine-learning model includes a large language model.

16. The method of claim 1, further comprising:
based on the member temporal parameter, automatically removing the user from the access group.

17. A system for managing data access, the system comprising:
one or more memories comprising instructions stored thereon; and
one or more processors configured to execute the instructions and perform operations comprising:
receiving a data access request for a user, the data access request including a resource indication of a data resource;
providing the user a membership of an access group associated with the data resource;
determining a member temporal parameter associated with the data resource based on one or more temporal parameters associated with the access group; and
associating the member temporal parameter with the user.

18. The system of claim 17, wherein the one or more temporal parameters associated with the access group include at least one selected from a group consisting of an access duration, an access expiration, an access maximum duration, a membership expiration, a membership duration, and a membership maximum duration.

19. The system of claim 17, wherein the one or more temporal parameters include a first temporal parameter and a second temporal parameter;
wherein the first temporal parameter is different from the second temporal parameter, wherein the first temporal parameter is set to a first time value and the second temporal parameter is set to a second time value;
wherein the determining a member temporal parameter includes:
determining a specific time value based on the first time value and the second time value; and
set the specific time value to the member temporal parameter.

20. A non-transitory computer-readable storage medium having instructions for managing data access that, when executed by one or more processors, cause the one or more processors to perform operations comprising:
receiving a data access request for a user, the data access request including a resource indication of a data resource;
providing the user a membership of an access group associated with the data resource;
determining a member temporal parameter associated with the data resource based on one or more temporal parameters associated with the access group; and
associating the member temporal parameter with the user.
